(19) United States
(12) Patent Application Publication
(10) Pub. No.: US 2014/0127348 A1
(43) Pub. Date: May 8, 2014

(54) Selective Positioning of Nozzle Tip Relative to Mold-Side of Runner System

(71) Applicant: HUSKY INJECTION MOLDING SYSTEMS LTD., Bolton (CA)

(72) Inventors: Martin Baumann, Burlington, VT (US); John Knapp, St. Albans, VT (US); Sarah Kathleen Overfield, Colchester, VT (US)

(73) Assignee: HUSKY INJECTION MOLDING SYSTEMS LTD., Bolton, ON (CA)

(21) Appl. No.: 14/127,556

(22) PCT Filed: Jun. 12, 2012
(86) PCT No.: PCT/US12/41994

§ 371 Date: Dec. 19, 2013

Related U.S. Application Data
(60) Provisional application No. 61/502,921, filed on Jun. 30, 2011.

(51) Int. Cl. B29C 45/07

(52) U.S. Cl. CPC B29C 45/07
USPC 425/568

(57) ABSTRACT

The inventors have researched a problem associated with known molding systems that inadvertently manufacture bad-quality molded articles or parts. After much study, the inventors believe they have arrived at an understanding of the problem and its solution, which are stated below, and the inventors believe this understanding is not known to the public. During operation, the gate orifice and nozzle tip position are fixed. The inventors believe that there appears to be no known mechanism that allows optimization of the tip to gate relationship. Known methods of adjusting position of a nozzle tip, such as shimming between a cavity plate and a manifold plate, or replacing nozzle stack components, may be time consuming and difficult. The known hot runner assembly often must be removed from the molding machine to make the desired adjustments.

### TECHNICAL FIELD

An aspect generally relates to (but is not limited to) a mold-tool system configured to selectively position a nozzle tip.

### BACKGROUND

U.S. Pat. No. 7,165,958 (E. JENKO) discloses an apparatus for adjustable hot runner assembly seals and tip height using active material elements. An apparatus is provided for sealing interfaces within an injection mold having a first surface and a second surface. An active material actuator is configured to be disposed in a manner suitable for generating a force between the first surface and the second surface. The active material actuator is configured to generate a force in response to sense signals from a transmission structure. Apparatus is also provided for centering a nozzle tip within a gate opening, and adjusting tip height of a nozzle tip with respect to a gate opening, also using active material inserts.

U.S. Pat. No. 7,632,450 (E. JENKO) discloses an adjustable hot runner assembly seals and tip height using active material elements. A method is disclosed for sealing interfaces within an injection mold having a first surface and a second surface. An active material actuator is configured to be disposed in a manner suitable for generating a force between the first surface and the second surface. The active material actuator is configured to generate a force in response to sense signals from a transmission structure. Methods are also provided for centering a nozzle tip within a gate opening, and adjusting tip height of a nozzle tip with respect to a gate opening, also using active material inserts.

United States Patent Publication Number 2004/0037914 (TAKEUCHI) discloses an injection mold having a hot-runner mold, a tip having low thermal conductivity is provided in the end face of a nozzle to enable the nozzle to directly nozzle-touch a cavity mold without a heat insulating sheet. A nozzle of a needle-valve-nozzle of the hot-runner mold is arranged on the bottom of a cavity mold. A nozzle body has an opening in its end face and a tip that is slidably fitted in the opening to protrude its flat end face from the end face of the nozzle body. The tip is made of metal having lower thermal conductivity than the nozzle body, whereby the nozzle can be constantly nozzle-touched to the cavity mold without the heat insulating sheet.

### SUMMARY

The inventors have researched a problem associated with known molding systems that inadvertently manufacture bad-quality molded articles or parts. After much study, the inventors believe they have arrived at an understanding of the problem and its solution, which are stated below, and the inventors believe this understanding is not known to the public.

During operation, the gate orifice and nozzle tip position are fixed. The inventors believe that there appears to be no known mechanism that allows optimization of the tip to gate relationship. Known methods of adjusting position of a nozzle tip, such as shimming between a cavity plate and a manifold plate, or replacing nozzle stack components, may be time consuming and difficult. The known hot runner assembly often must be removed from the molding machine to make the desired adjustments.

In order to provide a solution, at least in part, to the above problem, according to one aspect, there is provided a mold-tool system (100), comprising: a nozzle-tip positioning assembly (101) being configured to selectively position a nozzle tip (200) relative to a mold-side (917) of a runner system (916) between a first tip position (300) and a second tip position (304). Other aspects of the solution are identified in the claims.

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

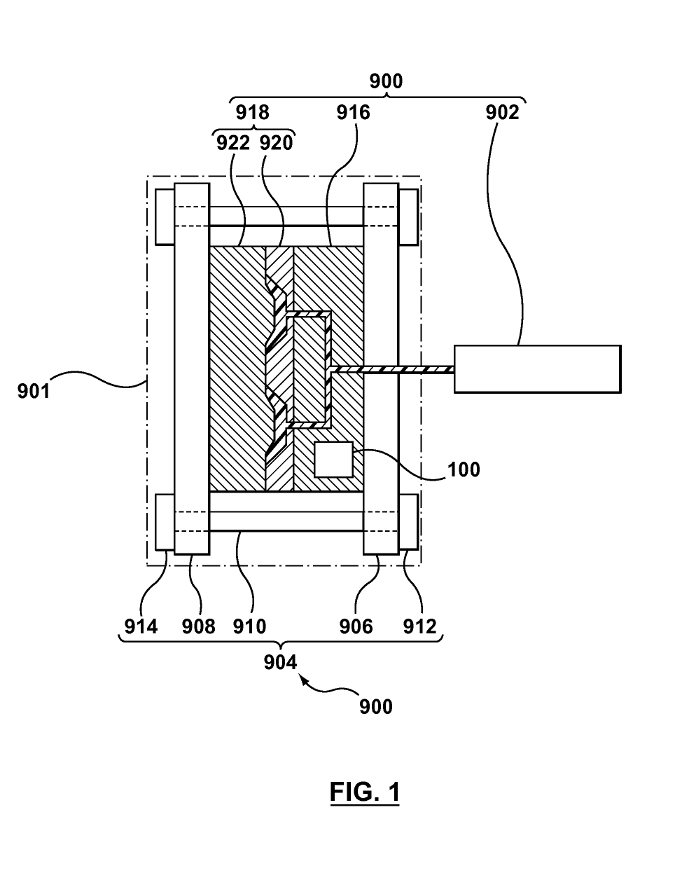

FIGS. 1, 2, 3, 4A, 4B, 4C, 5A, 5B, 5C depict schematic representations of a mold-tool system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 1, 2, 3, 4A, 4B, 4C, 5A, 5B, 5C depict the schematic representations of the mold-tool system (100). It will be appreciated that the examples depicted in the FIGS. may be combined in any suitable permutation and combination. The mold-tool system (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising.” The word “comprising” is a transitional phrase or word that links the preamble of a patent claim to the specific elements set forth in the claim that define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

FIG. 1 depicts a schematic representation of a molding system (900) having the mold-tool system (100). The molding system (900) may also be called an injection-molding system for example. According to the example depicted in FIG. 1, the molding system (900) includes (and is not limited to): (i) an extruder assembly (902), (ii) a clamp assembly (904), (iii) a runner system (916), and/or (iv) a mold assembly (918). By way of example, the extruder assembly (902) is configured, to prepare, in use, a heated, flowable resin, and is also configured to inject or to move the resin from the extruder assembly (902) toward the runner system (916). Other names for the extruder assembly (902) may include injection unit, melt-preparation assembly, etc. By way of example, the clamp assembly (904) includes (and is not limited to): (i) a stationary platen (906), (ii) a movable platen (908), (iii) a rod assembly (910), (iv) a clamping assembly (912), and/or (v) a lock assembly (914). The stationary platen (906) does not move; that is, the stationary platen (906) may be fixedly positioned relative to the ground or floor. The movable platen (908) is configured to be movable relative to the stationary platen (906). A platen-moving mechanism (not depicted but known) is connected to the movable platen (908), and the platen-moving mechanism is configured to move, in use, the movable platen (908). The rod assembly (910) extends between the movable platen (908) and the stationary platen (906). The rod assembly (910) may have, by way of example, four rod structures positioned at the corners of the respective stationary platen (906) and the movable platen (908). The rod assembly (910) is configured to guide movement of the movable platen (908) relative to the stationary platen (906). A clamping assembly (912) is connected to the rod assembly (910). The stationary platen (906) supports the position of the clamping assembly (912). The lock assembly (914) is connected to the rod assembly (910), or may alternatively be connected to the movable platen (908). The lock assembly (914) is configured to selectively lock and unlock the rod assembly (910) relative to the movable platen (908). By way of example, the runner system (916) is attached to, or is supported by, the stationary platen (906). The runner system (916) includes (and is not limited to) a mold-tool system (100). The definition of the mold-tool system (100) is as follows: a system that may be positioned and/or may be used in a platen envelope (901) defined by, in part, an outer perimeter of the stationary platen (906) and the movable platen (908) of the molding system (900) (as depicted in FIG. 1). The molding system (900) may include (and is not limited to) the mold-tool system (100). The runner system (916) is configured to receive the resin from the extruder assembly (902). By way of example, the mold assembly (918) includes (and is not limited to): (i) a mold-cavity assembly (920), and (ii) a mold-core assembly (922) that is movable relative to the mold-cavity assembly (920). The mold-core assembly (922) is attached to or supported by the movable platen (908). The mold-cavity assembly (920) is attached to or supported by the runner system (916), so that the mold-core assembly (922) faces the mold-cavity assembly (920). The runner system (916) is configured to distribute the resin from the extruder assembly (902) to the mold assembly (918).

In operation, the movable platen (908) is moved toward the stationary platen (906) so that the mold-cavity assembly (920) is closed against the mold-core assembly (922), so that the mold assembly (918) may define a mold cavity configured to receive the resin from the runner system (916). The lock assembly (914) is engaged so as to lock the position of the movable platen (908) so that the movable platen (908) no longer moves relative to the stationary platen (906). The clamping assembly (912) is then engaged to apply a clamping pressure, in use, to the rod assembly (910), so that the clamping pressure then may be transferred to the mold assembly (918). The extruder assembly (902) pushes or injects, in use, the resin to the runner system (916), which then the runner system (916) distributes the resin to the mold cavity structure defined by the mold assembly (918). Once the resin in the mold assembly (918) is solidified, the clamping assembly (912) is deactivated so as to remove the clamping force from the mold assembly (918), and then the lock assembly (914) is deactivated to permit movement of the movable platen (908) away from the stationary platen (906), and then a molded article may be removed from the mold assembly (918).

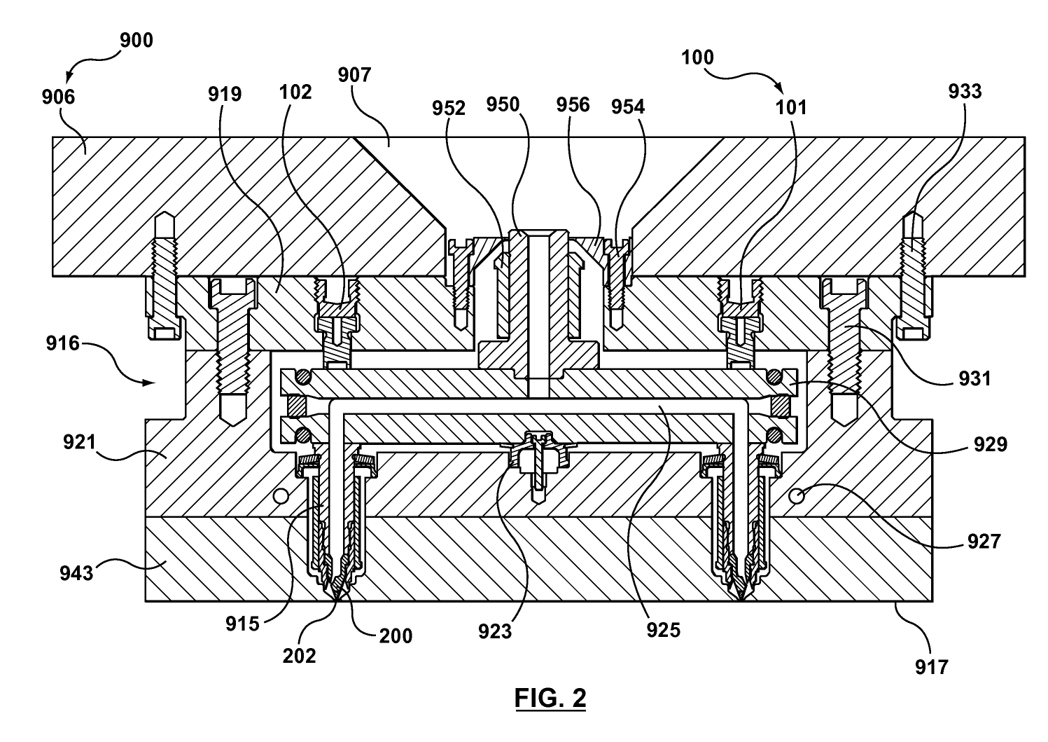

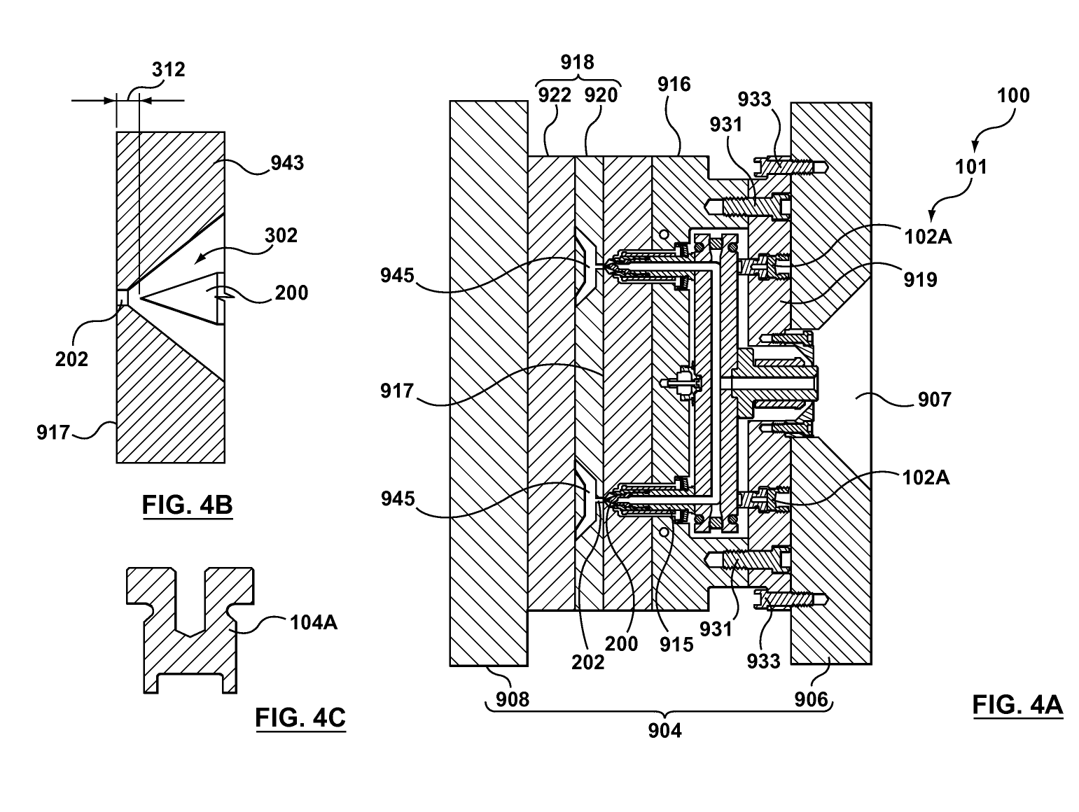

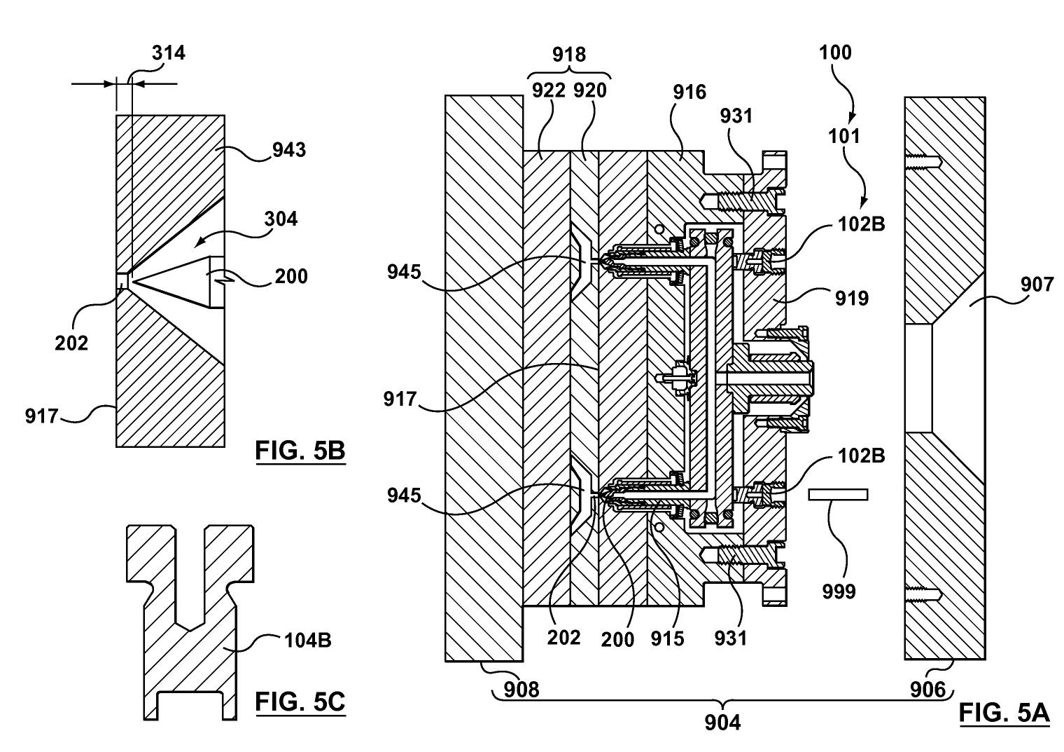

Referring now to FIG. 2, there is depicted an example of a close up view of the molding system (900) of FIG. 1. The stationary platen (906) defines a platen hole (907) configured to receive and accommodate a sprue assembly (950). A machine nozzle (known and not depicted) extends from the extruder assembly (902) (depicted in FIG. 1), and the machine nozzle is configured to interface with the sprue assembly (950), and transmit a flowable resin to the sprue assembly (905). By way of example, the sprue assembly (950) includes (and is not limited to): a sprue heater assembly (952), a sprue connector (954), and a sprue cover (956). The sprue heater assembly (952) is connected with the sprue assembly (950), and the sprue heater assembly (952) is configured to provide heat to the sprue assembly (950). The sprue cover (956) is positioned so as to cover the sprue assembly (950) as a safety precaution and to further insulate the sprue heater assembly (952) and help to retain heat adjacent to the sprue assembly (950). The sprue connector (954) if configured to connect and maintain position of the sprue cover (956) to the runner system (916). By way of example and not limited to the components depicted in FIG. 2, the runner system (916) includes: a nozzle tip (200), a gate (202), a nozzle assembly (915), a backing-plate assembly (919), a manifold plate (921), a manifold support (923), a cooling line (927), a manifold assembly (929), a plate connector (931), a backing plate connector (933), a mold cavity plate (943). The mold cavity plate (943) includes a mold side (917) of the runner system (916). Generally speaking, the mold side (917) faces the mold assembly (918); more specifically, the mold side (917) faces the mold-cavity assembly (920). The manifold assembly (929) defines a manifold melt channel (925). The sprue assembly (950) is in fluid communication with the manifold melt channel (925). The manifold melt channel (925) is configured to distribute the resin to at least one or more of the nozzle assembly (915). FIG. 2 depicts a simple example in which two of the nozzle assembly (915) for the sake of convenience. The nozzle assembly (915) abuts the manifold assembly (929). Each nozzle assembly (915) includes (and is not limited to): a nozzle tip (200) that extends from the nozzle assembly (915). The backing-plate assembly (919) is attached to the stationary platen (906) by way of the backing plate connector (933). The plate connector (931) is configured to attach the manifold plate (921) to the backing-plate assembly (919). The manifold plate (921) is configured to accommodate the manifold assembly (929). The manifold support (923) is positioned between the manifold assembly (929) and the manifold plate (921), and the manifold support (923) is configured to support and position the manifold assembly (929) within the manifold plate (921). The nozzle assembly (915) extends outwardly from the manifold plate (921). The cooling line (927) is defined in the manifold plate (921). The cooling line (927) is positioned proximate to the nozzle assembly (915). The cooling line (927) is configured to manage, in use, heating of the nozzle assembly (915). The mold cavity plate (943) is attached to the manifold plate (921). The mold cavity plate (943) is configured to accommodate the forward portion of the nozzle assembly (915) and the nozzle tip (200). The mold cavity plate (943) defines at least one or more of the gate (202) at the mold side (917) of the runner system (916). Each gate (202) is positioned proximate to a respective nozzle tip (200). Each of the gate (202) is an exit that permits the resin to flow from the nozzle tip (200) of the nozzle assembly (915) into a respective mold cavity (945) that are depicted in FIGS. 4A, 5B.

Generally speaking, according to a first example, the mold-tool system (100) includes (and is not limited to): the nozzle-tip positioning assembly (101) that is configured to selectively position the nozzle tip (200) relative the mold-side (917) of the runner system (916) between a first tip position (300) and a second tip position (304). The first tip position (302) is depicted in FIG. 4B. The second tip position (304) is depicted in FIG. 5B. It will be appreciated that generally speaking, the nozzle-tip positioning assembly (101) is positioned relative to the nozzle tip (200). It will also be appreciated that a range of tip positions are possible. It is understood that the nozzle-tip positioning assembly (101) that is configured to selectively position the nozzle tip (200) relative the mold-side (917) of the runner system (916) between or along a range of positions; the first tip position (300) and the second tip position (304) are merely examples of positions in which the nozzle tip (200) may be placed. The first tip position (300) is set apart from and the second tip position (304).

Generally speaking, according to a second example, the mold-tool system (100) includes (and is not limited to): (i) the nozzle tip (200), (ii) the runner system (916) having the mold-side (917), and (iii) the nozzle-tip positioning assembly (101). The nozzle-tip positioning assembly (101) is configured to selectively position the nozzle tip (200) relative to the mold-side (917) of the runner system (916) between a first tip position (300) and a second tip position (304). It will be appreciated that generally speaking, the nozzle-tip positioning assembly (101) is positioned relative to the nozzle tip (200).

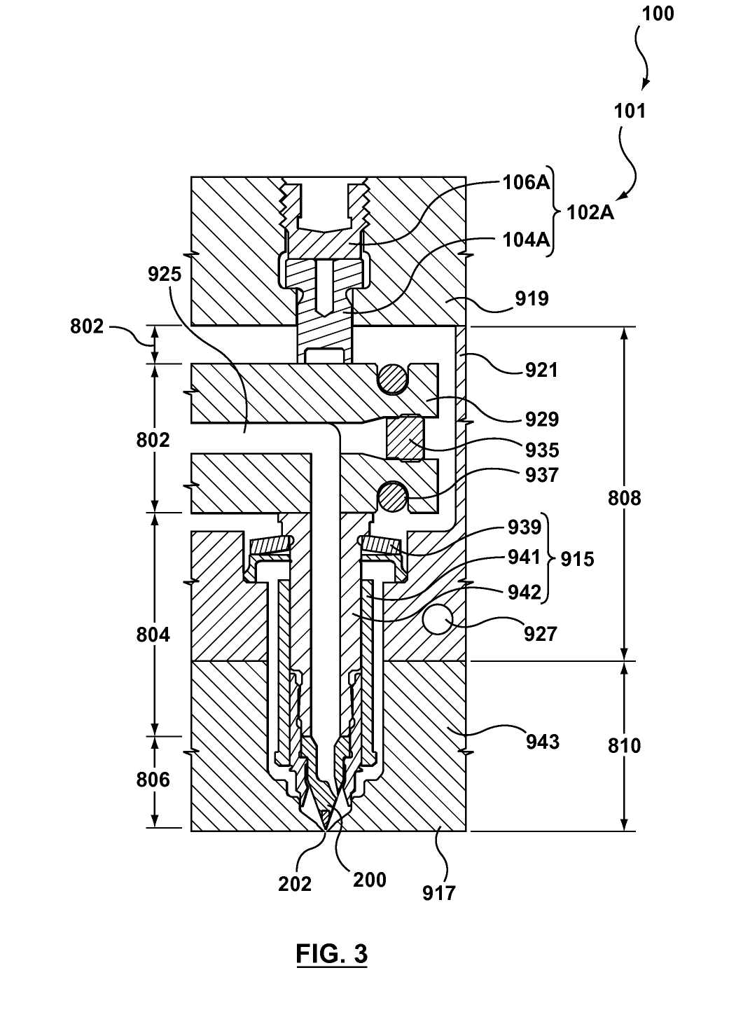

Referring now to FIG. 3, there is depicted a close-up view of a portion of FIG. 2 of the mold-tool system (100). The manifold plate (921) accommodates or houses the manifold assembly (929). A manifold plug (935) is positioned so as to prevent leakage from the manifold melt channel (925). A manifold heater (937) is connected to the manifold assembly (929), and the manifold heater (937) is configured to provide, in use, heat to the manifold assembly (929). By way of example and not limited to the components depicted in FIG. 3, the nozzle assembly (915) includes: a nozzle spring (939), a nozzle heater (941) and a nozzle body (942). The nozzle spring (939) is configured to bias the nozzle body (942) against the manifold assembly (929). The nozzle heater (941) is configured to apply heat, in use, to the nozzle body (942). The runner system (916) supports position of the nozzle tip (200).

The example depicted in FIG. 2 does not necessarily limit the components, arrangements and features of the nozzle-tip positioning assembly (101). The nozzle-tip positioning assembly (101) is positioned relative to the nozzle tip (200). The nozzle-tip positioning assembly (101) contacts the runner system (916) and contacts the backing-plate assembly (919) of the runner system (916). The nozzle-tip positioning assembly (101) is configured to: (i) be retainably supported by the backing-plate assembly (919); and (ii) support position of the runner system (916) relative to the backing-plate assembly (919).

According to a first variation (and not limited to the first variation), the nozzle-tip positioning assembly (101) includes (and is not limited to): a first-positioning assembly (102A) configured to position the nozzle tip (200) relative the mold-side (917) of the runner system (916) at the first tip position (302).

According to a second variation (and not limited to the first variation), the nozzle-tip positioning assembly (101) includes (and is not limited to): a first-positioning assembly (102A) configured to position the nozzle tip (200) relative the mold-side (917) of the runner system (916) at the first distance (312).

According to an example, the first-positioning assembly (102A) includes (and is not limited to: (i) a position-support component (104A), and (ii) a stop component (106A). The position-support component (104A) is configured to support position of the runner system (916) relative to the backing-plate assembly (919), so that the first distance (312) exists between an end of the nozzle tip (200) and the mold-side (917) of the runner system (916). The stop component (106A) is configured to stop movement of the position-support component (104A) relative to the backing-plate assembly (919), and the backing-plate assembly (919) being configured for connection to a stationary platen (906). The backing-plate assembly (919) is configured to accommodate support of the position-support component (104A) and the stop component (106A). According to a variation, the backing-plate assembly (919) may define a hole or recess that is configured to accommodate support of the position-support component (104A) and the stop component (106A). It will be appreciated that there are other ways and means for the backing-plate assembly (919) to be configured to accommodate support of the position-support component (104A) and the stop component (106A). The stop component (106A) is configured to stop movement of the position-support component (104A) relative to the backing-plate assembly (919). According to an example (and not limited to this example), the position-support component (104A) includes a shoulder portion that abuts with a ledge extending from the backing-plate assembly (919). According to an example (and not limited to this example), the stop component (106A) is fixedly connected to the backing-plate assembly (919), and the stop component (106A) abuts an end of the position-support component (104A).

Specifically, by changing a height of the position-support component (104A), the position of the nozzle tip (200) may be changed relative to the mold-side (917) at the gate (202). By way of example the height of the position-support component (104A) may be changed by replacing the position-support component (104A) with another position-support component, such as the position-support component (104B) that is depicted in FIG. 5B and the position-support component (104B) has a height that is different from the height of the position-support component (104A). It will be appreciated that other mechanisms may be used as functional replacements for the position-support component (104A).

Several embodiments of the position-support component (104A) may each have their own respective height, so the optimum length may be installed in the molding system (900) as may be required to deal with molding of a particular article. The position-support component (104A) may be retained in its position by the stop component (106A). Alternatively, the position-support component (104A) may be self retained relative to the backing-plate assembly (919). Generally speaking, the position-support component (104A) is retained to the backing-plate assembly (919). According to an example (and not limited to this example) the position-support component (104A) is adjustable instead of being replaceable; that is, the position-support component (104A) is height adjustable.

A first distance (800) is depicted as the height from a top surface of the manifold assembly (929) to the bottom surface of the backing-plate assembly (919). The first distance (800) is a variable distance. The first distance (800) is adjustably controlled by the mold-tool system (100). A second distance (802) is depicted as the height of the manifold assembly (929). The second distance (802) is a fixed distance (not variable). A third distance (804) is depicted as the height of the nozzle body (942). The third distance (804) is a fixed distance (not a variable distance). A fourth distance (806) is depicted as the height of the nozzle tip (200). The fourth distance (806) is a fixed distance (not a variable distance). A fifth distance (808) is depicted as the height of the manifold plate (921). The fifth distance (808) is a fixed distance (not a variable distance) A sixth distance (810) is depicted as the height from an end of the nozzle tip (200) to and end face of the manifold plate (921). The sixth distance (810) equals the first distance (800) plus the second distance (802) plus the third distance (804) plus the fourth distance (806) minus the fifth distance (808). The sixth distance (810) is a variable distance because the first distance (800) is a variable distance.

Referring now to FIGS. 4A, 4B, 4C, 5A, 5B, 5C, operation of the mold-tool system (100) is depicted (by way of example).

Referring now to FIG. 4A, the runner system (916) is attached to the stationary platen (906), and the molding system (900) may be operated to mold articles in the mold cavities (945). FIG. 4B depicts the first tip position (302), in which a first distance (312) exists between an end of the nozzle tip (200) and the mold-side (917) of the runner system (916) as a result of using the mold-tool system (100). FIG. 4C depicts an example of the position-support component (104A) that has a predetermined height that may be used to achieve the result depicted in FIG. 4B.

Referring now to FIG. 5A, the runner system (916) is detached from and separated from the stationary platen (906), so that the runner system (916) is set apart from the stationary platen (906). As depicted in FIG. 5A, the molding system (900) can be operated to mold articles. The first-positioning assembly (102A) as depicted in FIG. 4A is now replaced with a second-positioning assembly (102B). A tool (999) was used to remove the first-positioning assembly (102A) from the runner system (916), and was also used to install the second-positioning assembly (102B) to the runner system (916). According to an example (and not limited to the example), the nozzle-tip positioning assembly (101) includes: the second-positioning assembly (102B) that is configured to position the nozzle tip (200) relative the mold-side (917) of the runner system (916) at the second tip position (304) as depicted in FIG. 5B.

Referring now to FIG. 5B, for the second tip position (304), a second distance (314) exists between the end of the nozzle tip (200) and the mold-side (017), the first distance (312) (as depicted in FIG. 4B) being greater than (that is, different than) the second distance (314) (as depicted in FIG. 5B). The position-support component (104A) may be replaced or adjusted in the molding system (900) by latching the runner system (916) over to the mold-cavity assembly (920) thereby exposing the injection face of the backing-plate assembly (919) and the access hole that may accommodate the position-support component (104A). Generally speaking, the position-support component (104A) is either one of replaced and adjusted by latching the runner system (916) over to the mold-cavity assembly (920).

Preferably, the position-support component (104A) is either one of replaced and adjusted by latching the runner system (916) over to the mold-cavity assembly (920) in situ. The phrase or terminology “in situ” describes the condition or case where the runner system (916) is installed in the molding system (900). The opposite sense of “in situ” is the case where the runner system (916) is not installed in the molding system (900) but rather the runner system (916) is positioned on a work bench for example.

FIG. 5C depicts an example of the position-support component (104B) that has a predetermined height that may be used to achieve the result depicted in FIG. 5B. The height of position-support component (104B) (as depicted in FIG. 4C) is higher than or longer than the height of the position-support component (104A).

Referring now to FIG. 4A and FIG. 5A, the first-positioning assembly (102A) and the second-positioning assembly (102B) are replaceable with respect to each other.

Referring now to FIGS. 4B and 5B, the nozzle tip (200) is positionable further away from the mold-side (917) at the first tip position (302) (as depicted in FIG. 4B) in comparison to the position of the nozzle tip (200) at the second tip position (304) (as depicted in FIG. 5B).

In the runner system (916), improved molding of a part or article may be dependent upon a relationship between the end of the nozzle tip (200) and the gate (202) and the mold-side (917). The nozzle tip (200) may conduct sufficient heat to the gate (202) to allow the resin to flow during injection cycle, while not conducting so much heat that the gate (202) cannot freeze after injection of resin into the mold cavity (945). An annular resin flow path may be created at the gate (202) due to the proximity of the end of the nozzle tip (200) to the gate (202). The annular flow path is the largest restriction in the melt delivery system and generates high shear rates in the resin as well as a significant pressure drop (pressure loss). The shear rates and pressure drop are related to the annular flow area, which is governed by the position of the nozzle tip (200) with respect to the gate (202) and the mold-side (917). The position of the nozzle tip (200) with respect to the mold-side (917), in the gate, (202) is critical.

During normal operation of the molding system (900), the gate (202) and the position of the nozzle tip (200) are fixed. The mold-tool system (100) is configured to optimize positioning of the nozzle tip (200) to the mold-side (917) at the gate (202). Variation in molded part size, resin, throughput, and cycle requirements may result in a unique tip-in-gate positioning relationship. Usually hardware is provided with a single defined tip-to-mold face distance—that is, the distance between the nozzle tip (200) and the mold-side (917) of the runner system (916). This may be a compromise for some applications (that is, arrangements for molding articles) and may not produce acceptable molded parts in some cases. However, the mold-tool system (100) provides an approach for resolving the problem of adjusting the nozzle tip (200) in perhaps a more convenient way.

The examples of the mold-tool system (100) described above allows for optimized positioning of the nozzle tip 9200) in the molding system (900). In the molding system (900), variables of resin, part size, throughput, and cycle profile are known and the position of the nozzle tip (200) may be tuned to suit the particular needs of the application.

### ADDITIONAL DESCRIPTION

The following clauses are offered as further description of the examples of the mold-tool system (100): Clause (1): the mold-tool system (100), comprising: a nozzle-tip positioning assembly (101) being configured to selectively position a nozzle tip (200) relative to a mold-side (917) of a runner system (916) between a first tip position (300) and a second tip position (304). Clause (2): the mold-tool system (100), comprising: a nozzle tip (200); a runner system (916) having a mold-side (917); and a nozzle-tip positioning assembly (101) being configured to selectively position the nozzle tip (200) relative to the mold-side (917) of the runner system (916) between a first tip position (300) and a second tip position (304). Clause (3): the mold-tool system (100) of any clause mentioned in this paragraph, wherein: the nozzle-tip positioning assembly (101) is positioned relative to the nozzle tip (200). Clause (4): the mold-tool system (100) of any clause mentioned in this paragraph, wherein: the runner system (916) supports position of the nozzle tip (200), the nozzle-tip positioning assembly (101) is positioned relative to the nozzle tip (200), and the nozzle-tip positioning assembly (101) contacts the runner system (916) and contacts a backing-plate assembly (919) of the runner system (916). Clause (5): the mold-tool system (100) of any clause mentioned in this paragraph, wherein: the nozzle tip (200) is positionable further away from the mold-side (917) at the first tip position (302) in comparison to the position of the nozzle tip (200) at the second tip position (304). Clause (6): the mold-tool system (100) of any clause mentioned in this paragraph, wherein: for the first tip position (302), a first distance (312) exists between an end of the nozzle tip (200) and the mold-side (917) of the runner system (916); and for the second tip position (304), a second distance (314) exists between the end of the nozzle tip (200) and the mold-side (917), the first distance (312) being greater than (that is, being different than) the second distance (314). Clause (7): the mold-tool system (100) of any clause mentioned in this paragraph, wherein: the nozzle-tip positioning assembly (101) includes: a first-positioning assembly (102A) being configured to position the nozzle tip (200) relative the mold-side (917) of the runner system (916) at the first tip position (302); and a second-positioning assembly (102B) being configured to position the nozzle tip (200) relative the mold-side (917) of the runner system (916). Clause (8): the mold-tool system (100) of any clause mentioned in this paragraph, wherein: the first-positioning assembly (102A) and the second-positioning assembly (102B) are replaceable with respect to each other. Clause (9): the mold-tool system (100) of any clause mentioned in this paragraph, wherein: the nozzle-tip positioning assembly (101) is configured to: (i) be retainably supported by the backing-plate assembly (919); and (ii) support position of the runner system (916) relative to the backing-plate assembly (919). Clause (10); the mold-tool system (100) of claim 9, wherein: the nozzle-tip positioning assembly (101) includes: a first-positioning assembly (102A) being configured to position the nozzle tip (200) relative the mold-side (917) of the runner system (916) at the first distance (312), the first-positioning assembly (102A) includes: a position-support component (104A) being configured to support position of the runner system (916) relative to the backing-plate assembly (919), so that the first distance (312) exists between an end of the nozzle tip (200) and the mold-side (917) of the runner system (916). Clause (11): the mold-tool system (100) of any clause mentioned in this paragraph, wherein: the position-support component (104A) is retained to the backing-plate assembly (919). Clause (12): the mold-tool system (100) of any clause mentioned in this paragraph, wherein: the position-support component (104A) is either one of replaced and adjusted by latching the runner system (916) over to the mold-cavity assembly (920) in situ. Clause (13): the mold-tool system (100) of any clause mentioned in this paragraph, wherein: the nozzle-tip positioning assembly (101) includes: a first-positioning assembly (102A) being configured to position the nozzle tip (200) relative the mold-side (917) of the runner system (916) at the first distance (312), the first-positioning assembly (102A) includes: a position-support component (104A) being configured to support position of the runner system (916) relative to the backing-plate assembly (919), so that the first distance (312) exists between an end of the nozzle tip (200) and the mold-side (917) of the runner system (916), the position-support component (104A) is retained to the backing-plate assembly (919), and the position-support component (104A) is height adjustable. Clause (15): the mold-tool system (100) of any clause mentioned in this paragraph, wherein: the nozzle-tip positioning assembly (101) includes: a first-positioning assembly (102A) being configured to position the nozzle tip (200) relative the mold-side (917) of the runner system (916) at the first distance (312), the first-positioning assembly (102A) includes: a position-support component (104A) being configured to support position of the runner system (916) relative to the backing-plate assembly (919), so that the first distance (312) exists between an end of the nozzle tip (200) and the mold-side (917) of the runner system (916); and a stop component (106A) being configured to stop movement of the position-support component (104A) relative to the backing-plate assembly (919), and the backing-plate assembly (919) being configured for connection to a stationary platen (906).

It will be appreciated that the examples depicted in the FIGS. may be combined in any suitable permutation and combination. It will be appreciated that: (i) all of the above components, assemblies, etc, may: (i) all be sold separately or provided by a combination of multiple vendors, (ii) some vendors may provide a combination of a limited selection of the above components, assemblies, etc, or, (iii) a single vendor may provide all of the above of the above components, assemblies, etc. It will be appreciated the molding system (900) may have the mold-tool system (100), the runner system (916) may have the mold-tool system (100), the nozzle assembly (915) may have the mold-tool system (100).

It will be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components, or software code that is superior to any of the equivalents available to the art. There is no particular mode of practicing the inventions and/or examples of the invention that is superior to others, so long as the functions may be performed. It is believed that all the crucial aspects of the invention have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

What is claimed is:

1. A mold-tool system (100), comprising:
a nozzle-tip positioning assembly (101) being configured to selectively position a nozzle tip (200) relative to a mold-side (917) of a runner system (916) between a first tip position (300) and a second tip position (304).

2. A mold-tool system (100), comprising:
a nozzle tip (200);
a runner system (916) having a mold-side (917); and
a nozzle-tip positioning assembly (101) being configured to selectively position the nozzle tip (200) relative to the mold-side (917) of the runner system (916) between a first tip position (300) and a second tip position (304).

3. The mold-tool system (100) of claim 1, wherein:
the nozzle-tip positioning assembly (101) is positioned relative to the nozzle tip (200).

4. The mold-tool system (100) of claim 1, wherein:
the runner system (916) supports the position of the nozzle tip (200),
the nozzle-tip positioning assembly (101) is positioned relative to the nozzle tip (200), and
the nozzle-tip positioning assembly (101) contacts the runner system (916) and contacts a backing-plate assembly (919) of the runner system (916).

5. The mold-tool system (100) of claim 1, wherein:
the nozzle tip (200) is positionable further away from the mold-side (917) at the first tip position (302) in comparison to the position of the nozzle tip (200) at the second tip position (304).

6. The mold-tool system (100) of claim 1, wherein:
for the first tip position (302), a first distance (312) exists between an end of the nozzle tip (200) and the mold-side (917) of the runner system (916); and
for the second tip position (304), a second distance (314) exists between the end of the nozzle tip (200) and the mold-side (917),
the first distance (312) being different than the second distance (314).

7. The mold-tool system (100) of claim 1, wherein:
the nozzle-tip positioning assembly (101) includes:
a first-positioning assembly (102A) being configured to position the nozzle tip (200) relative the mold-side (917) of the runner system (916) at the first tip position (302); and
a second-positioning assembly (102B) being configured to position the nozzle tip (200) relative the mold-side (917) of the runner system (916).

8. The mold-tool system (100) of claim 1, wherein:
the first-positioning assembly (102A) and the second-positioning assembly (102B) are replaceable with respect to each other.

9. The mold-tool system (100) of claim 1, wherein:
the nozzle-tip positioning assembly (101) is configured to:
(i) be retainably supported by the backing-plate assembly (919); and
(ii) support the position of the runner system (916) relative to the backing-plate assembly (919).

10. The mold-tool system (100) of claim 9, wherein:
the nozzle-tip positioning assembly (101) includes:
a first-positioning assembly (102A) being configured to position the nozzle tip (200) relative the mold-side (917) of the runner system (916) at the first distance (312), the first-positioning assembly (102A) includes:
a position-support component (104A) being configured to support the position of the runner system (916) relative to the backing-plate assembly (919), so that the first distance (312) exists between an end of the nozzle tip (200) and the mold-side (917) of the runner system (916).

11. The mold-tool system (100) of claim 10, wherein:
the position-support component (104A) is retained to the backing-plate assembly (919).

12. The mold-tool system (100) of claim 10, wherein:
the position-support component (104A) is either one of replaced and adjusted by latching the runner system (916) over to the mold-cavity assembly (920) in situ.

13. The mold-tool system (100) of claim 9, wherein:
the nozzle-tip positioning assembly (101) includes:
a first-positioning assembly (102A) being configured to position the nozzle tip (200) relative the mold-side (917) of the runner system (916) at the first distance (312), the first-positioning assembly (102A) includes:
a position-support component (104A) being configured to support the position of the runner system (916) relative to the backing-plate assembly (919), so that the first distance (312) exists between an end of the nozzle tip (200) and the mold-side (917) of the runner system (916), the position-support component (104A) is retained to the backing-plate assembly (919), and the position-support component (104A) is height adjustable.

14. The mold-tool system (100) of claim 9, wherein:
the nozzle-tip positioning assembly (101) includes:
a first-positioning assembly (102A) being configured to position the nozzle tip (200) relative the mold-side (917) of the runner system (916) at the first distance (312), the first-positioning assembly (102A) includes:
a position-support component (104A) being configured to support the position of the runner system (916) relative to the backing-plate assembly (919), so that the first distance (312) exists between an end of the nozzle tip (200) and the mold-side (917) of the runner system (916); and
a stop component (106A) being configured to stop movement of the position-support component (104A) relative to the backing-plate assembly (919), and the backing-plate assembly (919) being configured for connection to a stationary platen (906).

15. A molding system (900) having the mold-tool system (100) of any preceding claim.

16. A runner system (916) having the mold-tool system (100) of any preceding claim.

17. A nozzle assembly (915) having the mold-tool system (100) of any preceding claim.
